(19) United States
(12) Patent Application Publication
(10) Pub. No.: US 2009/0101027 A1
(43) Pub. Date: Apr. 23, 2009

(54) Screen Printing Device

(75) Inventors: Harry Goetz, Schwanau (DE); Dietmar Weber, Reute (DE)

Correspondence Address: CROWELL & MORING LLP;INTELLECTUAL PROPERTY GROUP, P.O. BOX 14300, WASHINGTON, DC, 20044-4300, US

(73) Assignee: Thieme GmbH & Co. KG, Teningen (DE)

(21) Appl. No.: 11/883,572

(22) PCT Filed: Jan. 31, 2006
(86) PCT No.: PCT/EP2006/000788

§ 371 Date: May 7, 2008

(30) Foreign Application Priority Data
Feb. 2, 2005 (DE) 102005006732.8

(51) Int. Cl. B05C 17/04

(52) U.S. Cl. 101/123

(57) ABSTRACT

A printing installation for printing on curved surfaces, includes a squeegee, a printing screen maintained in a screen frame, and a drive for moving the squeegee. The screen frame, on at least one side thereof, is flexible in at least some sections thereof. The screen printing device is used, for example, for printing on curved vehicle window panes.

### BACKGROUND AND SUMMARY OF THE INVENTION

The present invention relates to a screen printing device for printing curved surfaces, having a squeegee, a printing screen retained in a screen frame, and a mechanism for moving the squeegee.

The problem results in screen printing when printing molded parts that the screen printing fabric may only be tailored to this contour in a limited way. Typically, the fabric is stretched on a fixed frame and pressed onto the contour of the object to be printed using the squeegee. The limit of this overprinting is in the possible screen stretching. This means that the fabric must be extremely stretched at specific points to allow the required lengthening. This stretching of the printing screen additionally causes, besides strong strain of the fabric, a distortion in the printed image. This is true, in particular, if the contour of the object to be printed changes in the squeegee direction.

Pre-bending screen frames in the printing direction to counteract this problem is known. However, this does not help when printing the curved inner side of trough-like parts if the upper terminus surface, which is spanned by the edge of the trough-like part, is relatively planar. In addition to the high stretching in partial areas of the screen fabric, wrinkling also occurs here in areas in which the screen fabric may no longer have tension because of the inadequate accommodation by the frame.

The present invention is based on the object of providing a screen printing device for printing curved surfaces, where, by using such a device, even strongly curved surfaces, particularly having changing curvature, may be printed with high printing quality.

According to the present invention, for this purpose, a screen printing device is provided for printing curved surfaces having a squeegee, a printing screen retained in a screen frame, and a mechanism or drive for moving the squeegee, in which the implemented screen frame is as at least partially flexible on at least one side.

Because the screen frame implemented is at least partially flexible, it may yield upon high screen tension, so that even on strongly curved contours, the screen may be pressed onto the object to be printed without exceeding the maximum permissible fabric stretching. Simultaneously, the fabric length may be dimensioned such that no wrinkling occurs—even in areas of the screen fabric which become relaxed again in the course of the printing procedure.

In a refinement of the present invention, the at least one flexibly implemented side of the screen frame runs parallel to the printing direction.

Especially in the event of a contour of an object to be printed which changes in the printing direction, the flexible design of the sides of the screen frame running parallel to the printing direction allows adaptation of the screen frame to the contour just printed. Exceeding the maximum permissible screen tension is thus avoided, even with strongly curved objects or a changing contour.

In a refinement of the present invention, the at least one flexibly implemented side of the screen frame is formed using a belt made of elastic material. The belt advantageously has a trapezoidal cross section.

Providing a belt, such as a rubber belt, as a side of the screen frame allows this flexible, elastic design.

In a refinement of the present invention, the at least partially flexibly implemented side of the screen frame is guided in a guide in the area of a neighboring, lateral end of the squeegee.

By providing a guide, exactly reproducible printing results may be achieved even with a flexible screen frame. A reproducible position and tension of the screen in relation to the squeegee may especially be ensured using a guide. The guide is advantageously implemented as a roller guide.

During the printing procedure, using the guide rolls on the flexible sides of the screen frame, very exact guiding can be achieved using a trapezoidal belt and a correspondingly tailored roller guide. If necessary, the screen frame may have teeth on its flexible side, to allow especially exact and reproducible length assignment between the guide and the flexible longitudinal sides of the screen frame.

In a refinement of the present invention, the guide is situated on a squeegee bar movable in the printing direction. Alternatively, the guide may also be situated on a lateral end of the squeegee holder. In both cases, the flexible sides of the screen frame are thus guided exactly during the printing procedure in the area of the squeegee, so that reproducible tensions of the screen fabric transversely and parallel to the printing direction also result in the area of the squeegee.

In a refinement of the present invention, the guide is situated so it is movable in relation to the squeegee for defined tensioning of the printing screen. In this way, a tension of the printing screen in relation to the squeegee may be kept at a constant or predefinable value and the screen tension may be tailored, in particular, in the event of a contour of an object to be printed, which changes in the printing direction. The guide is advantageously situated on an adjustable lift cylinder. The lift cylinder may be situated, for example, on a squeegee bar or also directly on the lateral end of the squeegee holder.

In a further refinement of the present invention, the screen frame, viewed in the printing direction, is designed to be at least partially flexible at least on its front or rear side. In this way, a tension of the printing screen parallel to the printing direction may also be maintained within allowed limits.

In a refinement of the present invention, the front or rear side of the screen frame is connected, using a compensation device, to a retainer. The compensation device allows a screen tension force distribution which is adjustable in a defined way over the front or rear side of the screen frame.

Using the compensation device, it may be ensured that a desired distribution of the tension force in the screen is maintained over the entire printing procedure. Asymmetrically introduced tension forces may especially be compensated for to avoid distortion of the printing screen during the printing procedure. The retainer of the printing screen is, for example, attached to a printing unit frame, on which a squeegee holder is also situated so it is longitudinally displaceable, for example.

In a refinement of the present invention, the compensation device has at least one lever situated parallel to the front or rear side of the screen frame, which is attached on one hand, to the retainer so it is pivotable and, on the other hand, to the front or rear side of the screen frame so it is pivotable.

Using such a lever, a mechanical compensation device may be provided, which ensures uniform tension force distribution over the front or rear side of the screen frame. The tension force distribution may be varied by adapting the lever ratios.

In a refinement of the present invention, the squeegee holder is configured to be flexible and adjustment units are provided to adapt the squeegee holder during the printing procedure in accordance with a contour of an object to be printed.

Objects whose contour changes strongly parallel to the squeegee, viewed over the printing length, may also be printed using an adjustable squeegee holder. A flexibly implemented squeegee holder may be adjusted using pneumatic cylinders during the printing procedure, for example. A guide for the flexible sides of the screen frame is then advantageously provided at the two ends of the squeegee holder and pneumatic cylinders are also advantageously provided for adjusting the guides, to be able to adapt a tension of the printing screen to the squeegee during the printing procedure.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective, partial view of a screen printing device according to a first embodiment of the present invention;

FIG. 2 shows a sectional view of the screen printing device of FIG. 1 from the front, the section solely running through the printing screen;

FIG. 3 shows a detail of the screen printing device of FIG. 1;

FIG. 4 shows a partial view of the screen printing device of FIG. 1 from above in the area of the side of a screen frame lying to the rear in the printing direction;

FIG. 5 shows a schematic, partial illustration of a screen printing device according to a second embodiment of the present invention; and

FIG. 6 shows a sectional view of the screen printing device of FIG. 5 from the front, only the printing screen being shown in section.

### DETAILED DESCRIPTION OF THE DRAWINGS

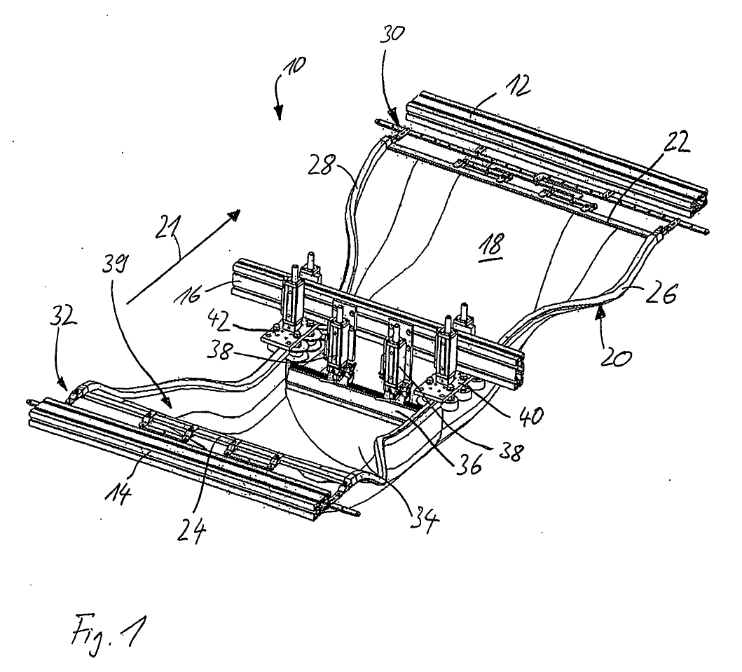

A screen printing device 10 is partially shown in the perspective view of FIG. 1. The screen printing device has a printing unit frame, of which only a front transverse bar 12 and a rear transverse bar 14, viewed in the printing direction, are shown in FIG. 1. The front transverse bar 12 and the rear transverse bar 14 are connected to one another using two longitudinal girders (not shown) to form a frame. A squeegee bar 16 is guided on the printing unit frame so it is longitudinally displaceable, only the squeegee bar 16 itself being shown, but not its connection to the longitudinal girders of the printing unit frame (also not shown). The printing unit frame and the longitudinally-displaceable mounting of the squeegee bar 16 thereon may be implemented in a conventional way, alternatively, however, the squeegee bar 16 may also be guided using one or more robot arms.

The screen printing device 10 has a printing screen 18, which is connected using a screen frame 20 to the front transverse bar 12 and the rear transverse bar 14. A printing direction runs from bottom left to top right in the illustration of FIG. 1, corresponding to the arrow 21, which thus also indicates the movement of the squeegee bar 16 during a printing procedure. The screen frame 20 has a side 22 lying in front in the printing direction, a side 24 lying in back in the printing direction, as well as a side 26 on the right in the printing direction and a side 28 on the left in the printing direction. The sides 26, 28 lying on the right and left in the printing direction are formed using a flexible and elastic belt. The sides 22, 24 lying in the front and rear in the printing direction are formed using a flexible rod, the front side 22 being held on the front transverse bar 12 using a compensation device 30 and the side 24 lying in the rear in the printing direction being connected using an identical compensation device 32 to the rear transverse bar 14. The compensation devices 30, 32 ensure that tension forces may be introduced uniformly into the printing screen 18 over the entire width of the screen 18, while maintaining a fixed position even in the event of deformation of the front side 22 or the rear side 24. The compensation devices 30, 32 will be explained in greater detail in the following.

The screen printing device 10 also has a squeegee 34, which is implemented in the shape of a circular section in the embodiment shown to print a cylindrical depression. The squeegee 34 is attached to an essentially rigid squeegee holder 36, which is in turn connected to the squeegee bar 16 using two pneumatic cylinders 38.

The flexible longitudinal sides 26, 28 of the screen frame 20 are each guided on the squeegee bar 16 using a roller guide 40, 42. The roller guides 40, 42 each have three pairs of rollers, between which the belt which forms the flexible sides 26, 28 is received. The rollers of the guides 40, 42 are adjustable in height in relation to the squeegee bar to be able to adjust a tension of the printing screen 18 in relation to the squeegee 34 during the printing procedure.

As may be seen in FIG. 1, the flexible sides 26, 28 of the screen frame 20 are exactly guided by the roller guides 40, 42 in the area of the squeegee 34, so that there is always a defined screen tension during the actual printing procedure in the area of the squeegee 34. Nonetheless, the screen tension may be kept low in comparison to a rigid screen frame, because the printing screen 18 is tensioned around the contour of the squeegee 34, so that the printing screen 18 does not, as in conventional screen printing devices, have to be pressed into the contour of an object to be printed starting from a planar and already tensioned state. Furthermore, it may be seen that after the actual printing procedure, the printing screen 18 may relax again, the flexible sides 26, 28 being implemented as rubber belts and thus also holding the printing screen without wrinkles in the relaxed areas, such as the area 39. It may thus be ensured that after the printing procedure by the squeegee 34, the printing screen 18 lifts off reliably from the object to be printed and thus allows a high printing quality.

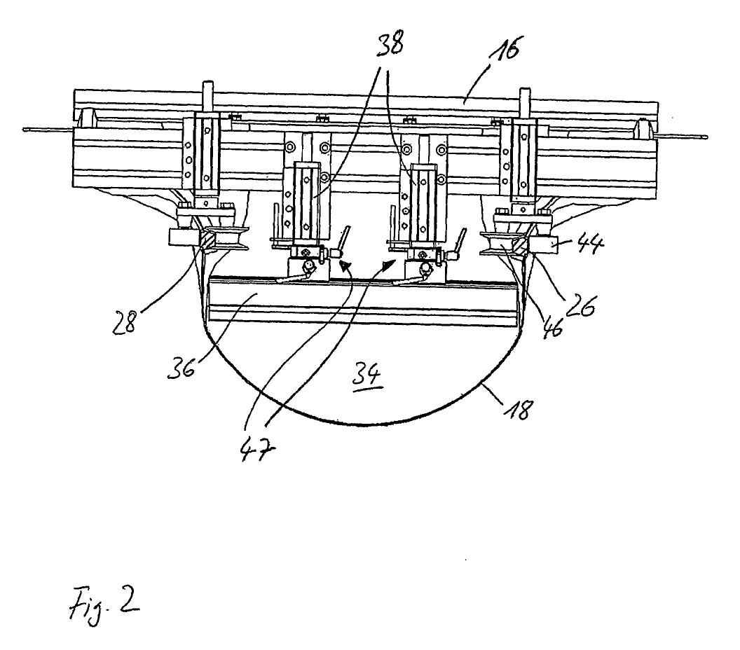

A front view of the screen printing device 10 of FIG. 1 is shown in the illustration of FIG. 2, a section having been performed behind the squeegee bar 16 viewed in the printing direction, so that only the printing screen 18 is shown in section. The particular trapezoidal cross section of the belts, which form the flexible sides 26, 28 of the screen frame 20, may be seen well in FIG. 2. The trapezoidal belts are guided in each case using pairs of rollers, which have an external cylindrical roller 44 and an internal roller 46 having a trapezoidal receptacle groove. Tension forces may be introduced reliably and reproducibly into the printing screen 18 by the trapezoidal design of the belt and the special implementation of the roller pairs 44, 46, and, in addition, a slip-free rolling movement of the rollers 46, 44 on the trapezoidal belt is ensured. Exactly reproducible positioning of printing screen 18 to the squeegee 34 may thus also be ensured in the printing direction.

The squeegee 34 is attached to the squeegee holder 36, which, in turn, is connected using the pneumatic cylinders 38 to the squeegee bar 16. A contact pressure of the squeegee 34 against the object to be printed may be set using the pneumatic cylinders 38. The squeegee holder 36 may be changed in its angle to the pneumatic cylinders 38 using two adjustment devices 47.

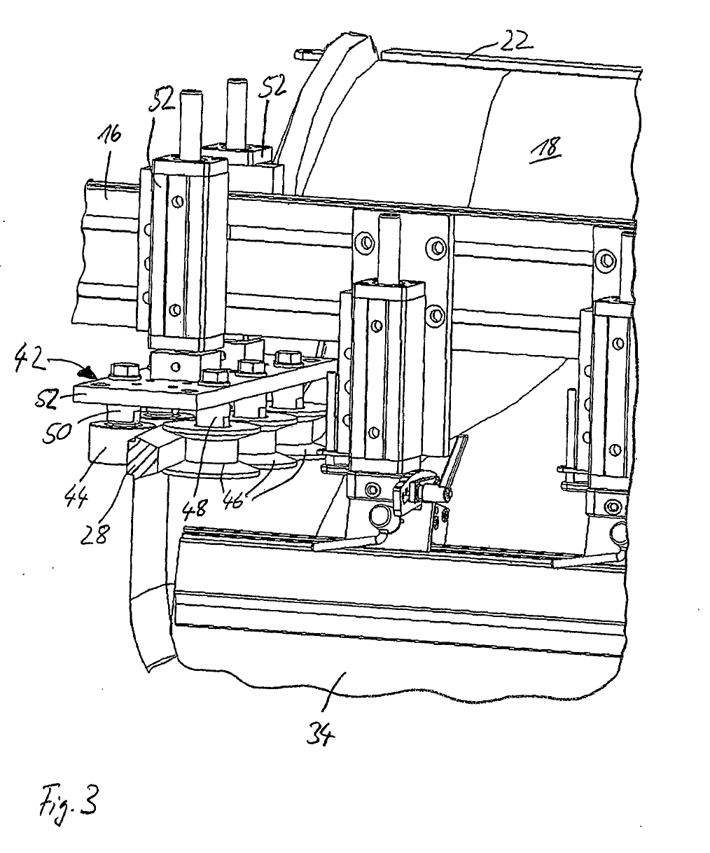

The left roller guide 42 viewed in the printing direction may be seen more precisely in the detail view of FIG. 3. Overall, three pairs of rollers are provided, each pair of rollers having a cylindrical roller 44 and a roller 46 having a trapezoidal running groove. The rollers 46, 44 are each mounted so they are rotatable on an assigned axis 48, 50. The axes 48, 50 are each connected to a base plate 52. The base plate 52 is, in turn, connected to the squeegee bar 16 so it is adjustable using the pneumatic cylinders 54. In addition, the rollers 44, 46 may be displaced on their particular axes 48, 50 to be able to change a distance of the rollers 44, 46 to the base plate 52. A screen tension may thus be set variably if needed over the length of the roller guide 42, for example, to avoid sudden changes of the screen tension in the area of the squeegee 34 in critical areas. The distance of the rollers 44, 46 to the base plate 42 may be designed as adjustable during the printing procedure, for example, in such a way that a constant screen tension is achieved at every instant during the entire printing procedure.

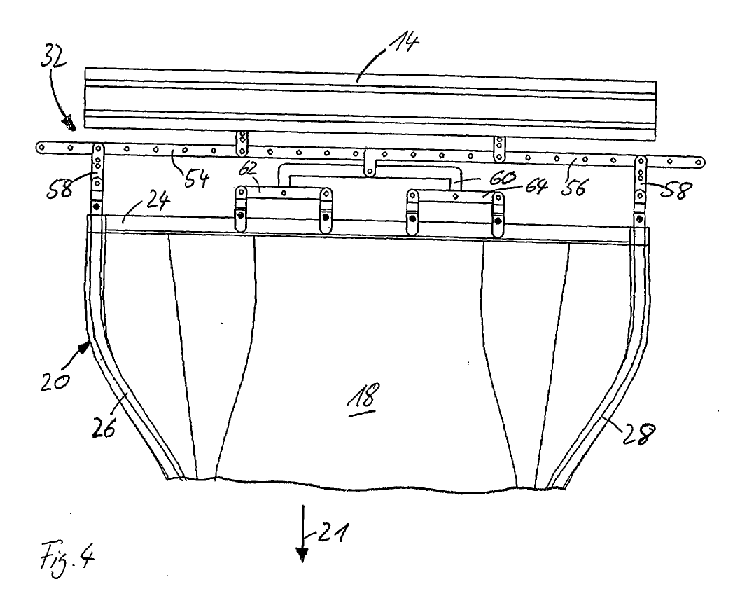

The illustration of FIG. 4 shows a top view of the transverse bar 14 lying to the rear in the printing direction, as well as the assigned rear end of the printing screen 18. The side 24 of the screen frame 20 lying to the rear in the printing direction is connected using the compensation device 32 to the rear transverse bar 14. The rear side 24 of the screen frame 20 is connected at a total of six points to the compensation device 32, these six attack points being situated symmetrically to the middle of the rear side 24. Two attachment points lie in an extension of the right side 26 or the left side 28 of the screen frame 20 viewed in the printing direction, so that actually the ends of the belt which forms the flexible sides 26, 28 are connected to the compensation device 32. Two further right and two further left attachment points are situated distributed symmetrically to the middle of the rear side 24. The attachment points situated in an extension of the belt are connected to a right compensation lever 54 or to a left compensation lever 56 viewed in the printing direction 21. The connection of these external attachment points to the compensation levers 54, 56 is performed, in each case, using an extension part 58 connected in an articulated way on both sides. The two compensation levers 54, 56 are also connected to one another in an articulated way in an extension of the middle of the rear side 24. The two compensation levers 54, 56 are each connected in an articulated way to the rear transverse bar 14 centrally between the articulated connection of the two compensation levers 54, 56 and the articulated attachment of the right or left extension part 58. A U-shaped bow 60 also engages in an articulated way at the connection point of the two compensation levers 54, 56, which is implemented as symmetrical and is, in turn, connected at its two free ends in an articulated way to a right transverse bar 62 and a left transverse bar 64. The right transverse bar 62 and the left transverse bar 64 are, in turn, connected at their ends in an articulated way to the rear side 24 of the screen frame 20.

As shown in FIG. 4, the compensation device 32 is constructed completely symmetrically around the middle of the rear side 24 of the screen frame 20, so that tension forces acting in the belts which form the sides 26, 28 are introduced symmetrically into the rear side 24. The rear side of the screen frame is held at a constant, uniform distance to the rear transverse bar 14 by the compensation device 32 and nonetheless the tension forces are introduced into the screen 18 uniformly over the entire screen width. A tension force distribution is adjustable by changing the lever ratios. The possibility of adjusting the lever ratios results, for example, in that the articulated attachment points of the compensation levers 54, 56 on the rear transverse bar 14 may be displaced laterally.

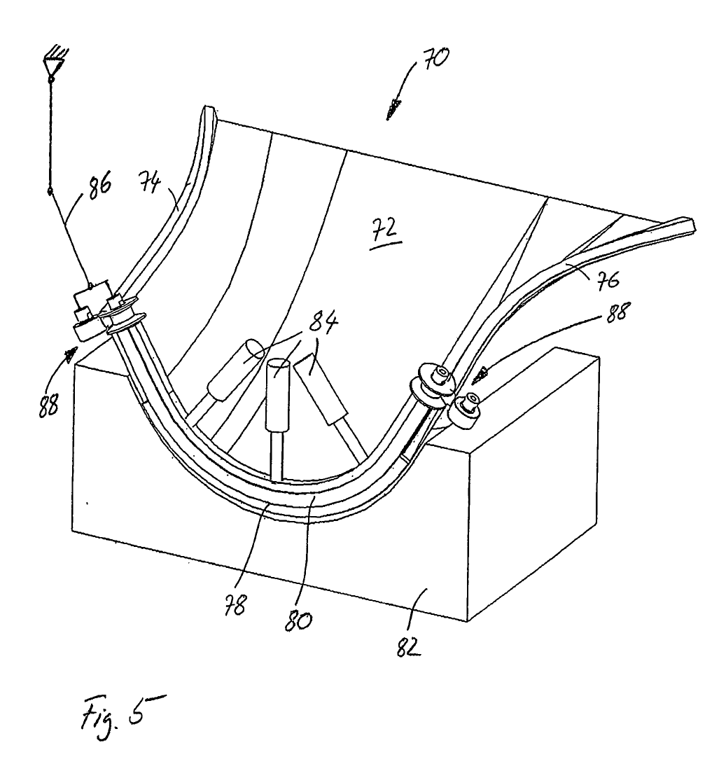

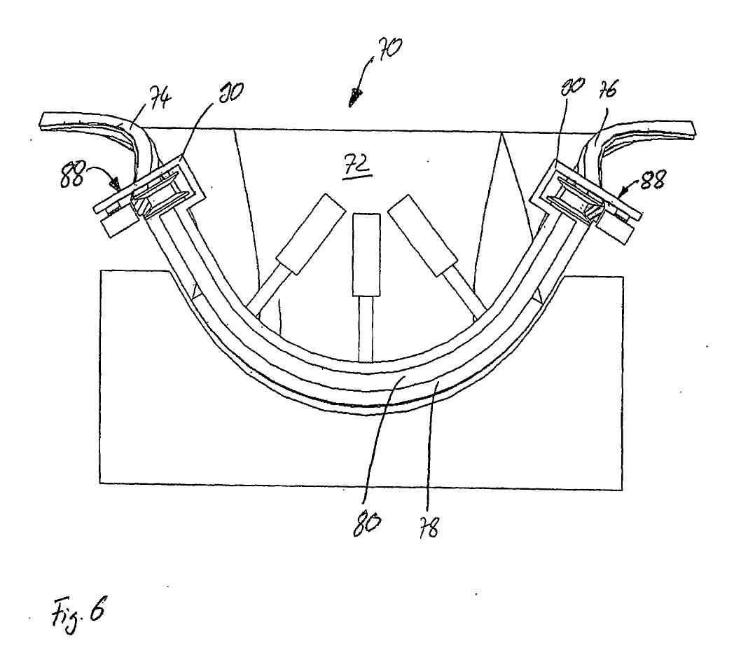

A screen printing device 70 according to a further embodiment of the present invention is schematically illustrated in the perspective, sectional illustration of FIG. 5 and the sectional front view of FIG. 6. The screen printing device 70 has a printing screen 72, which is shown in detail and has a flexible belt 74, 76 having a trapezoidal cross section on each of its longitudinal sides. The screen printing device 70 has a strip-shaped squeegee 78, which is attached to a squeegee holder 80. To adapt the squeegee 78 to a contour of an object 82 to be printed, which possibly changes in the printing direction, the squeegee holder 80 is implemented as flexible and a curve of the squeegee holder 80 may be adjusted transversely to the printing direction using three adjustment cylinders 84. The flexible, strip-shaped squeegee 78 follows the shape change of the squeegee holder 80. For the sake of clarity, no buttress for the adjustment cylinders 84 is shown in the schematic illustrations of FIGS. 5 and 6. Guide units for the squeegee holder 80, which move it in the printing direction, are also only schematically indicated using a two-joint guide arm 86. The guide arm 86 may assume the guiding of the left end of the squeegee holder 80 in the illustration of the figure, an identical guide arm would then be required for guiding the right end of the squeegee holder in FIG. 5. The adjustment cylinders 84 may, for example, be attached to a connection of these two guide arms. However, crank guides may also be provided, for example, alternatively to the guide arms 86, such as arms of a freeform robot.

A roller guide 88 is schematically indicated on each end of the squeegee holder 80, which guides the belts 74, 76 analogously to the roller guides explained on the basis of FIGS. 1 through 4. To also achieve a tension of the printing screen 72 transversely to the printing direction, i.e., along the squeegee 78, the roller guides 88 are situated so they are displaceable to the squeegee holder 80. As already explained, the belts 74, 76 are guided in the roller guides 88 and the roller guides 88 are displaced pneumatically in relation to the squeegee holder 80, for example. L-shaped bows 90, which are only indicated in FIG. 6, may be provided to attach the roller guides 88 to the squeegee holder 80.

The screen printing device 70 schematically illustrated in FIGS. 5 and 6 also allows objects 82 having a curvature changing in the printing direction to be printed precisely. This is because, above all, the squeegee holder 80 may have its curve tailored to a changing curvature and the flexible squeegee 78 may follow this curve. Not only variable shaping, but rather also defined contact pressure of the squeegee 78 over the printing width may be achieved using the adjustment cylinders 84. A screen tension is achieved using the displaceable roller guides 88. It may be ensured because of the flexible belts 74, 76 on the sides of the screen frame that a maximum allowed screen stretching is not exceeded and no wrinkling occurs even in areas in which the screen becomes relaxed behind the squeegee.

Surprisingly, even trough-like objects, for example, specially shaped rear windows of vehicles, may be printed using screen printing at high printing quality by the present invention. Further, surprisingly, a high printing quality is allowed with reproducibility without problems, in spite of the fact that because of the flexible design of at least one side of the screen frame, an orientation of the printing screen to the object to be printed and the squeegee at first appears problematic. According to an embodiment of the present invention, a roller guide may be used for especially exact positioning and guiding of the flexible screen frame side. In spite of dispensing with a rigid screen frame, a high printing quality may thus be achieved even with objects to be printed having complicated shapes.

1-14. (canceled)

15. A screen printing device for printing curved surfaces, comprising:
a squeegee;
a screen frame having screen frame sides;
a printing screen held in the screen frame;
a drive operatively configured to move the squeegee; and
wherein at least one of the screen frame sides is at least partially flexible.

16. The screen printing device according to claim 15, wherein the at least one screen frame side extends parallel to a printing direction of the screen printing device.

17. The screen printing device according to claim 16, wherein the at least one screen frame side is formed using a belt made of elastic material.

18. The screen printing device according to claim 17, wherein the belt has a trapezoidal cross section.

19. The screen printing device according to claim 15, wherein the at least one screen frame side is guided in a guide in the area of a neighboring, lateral end of the squeegee.

20. The screen printing device according to claim 19, wherein the guide is configured as a roller guide.

21. The screen printing device according to claim 19, wherein the guide is situated on a squeegee bar movable in a printing direction of the screen printing device.

22. The screen printing device according to claim 20, wherein the guide is situated on a squeegee bar movable in a printing direction of the screen printing device.

23. The screen printing device according to claim 19, wherein the guide is situated on a lateral end of a squeegee holder.

24. The screen printing device according to claim 20, wherein the guide is situated on a lateral end of a squeegee holder.

25. The screen printing device according to claim 20, wherein the guide is situated to be movable in relation to the squeegee for defined tensioning of the printing screen.

26. The screen printing device according to claim 25, wherein the guide is situated on an adjustable lift cylinder.

27. The screen printing device according to claim 15, wherein the screen frame is configured to be at least partially flexible on at least one of a front or rear side viewed in a printing direction.

28. The screen printing device according to claim 27, wherein the front or rear side of the screen frame is connected to a holder using a compensation device, the compensation device allowing a screen tension force distribution, which is adjustable in a defined way over the front or rear side of the screen frame.

29. The screen printing device according to claim 28, wherein the compensation device has at least one lever situated parallel to the front or rear side of the screen frame, which lever is attached pivotably to the holder and pivotably to the front or rear side of the screen frame.

30. The screen printing device according to claim 23, wherein the squeegee holder is configured to be flexible, and adjustment devices are provided to adapt the squeegee holder according to a contour of an object to be printed during a printing procedure.
